(19) United States
(12) Patent Application Publication
(10) Pub. No.: US 2005/0069457 A1
(43) Pub. Date: Mar. 31, 2005

(54) Gas sensor with zinc oxide layer and method for forming the same

(75) Inventors: Chuan-De Huang, Tu-Cheng (TW); Wen-Jeng Huang, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 10/928,679

(22) Filed: Aug. 26, 2004

(30) Foreign Application Priority Data
Sep. 30, 2003 (TW) 092126963
Sep. 30, 2003 (TW) 092129257

(51) Int. Cl. G01N 27/02

(52) U.S. Cl. 422/88

(57) ABSTRACT

A gas sensor (3) includes: a base (30), two electrodes (31, 32) formed on the base, a zinc oxide layer (34) formed on surfaces of the base and the electrodes. The zinc oxide layer includes a plurality of zinc oxide nanofibers, each having a columnar or a tubular microstructure. Preferably, the zinc oxide nanofibers are substantially parallel to each other and substantially perpendicular to the base and electrodes. Numerous apertures between adjacent zinc oxide nanofibers can retain gas molecules. If the microstructure is tubular, apertures within the zinc oxide nanofibers can also retain gas molecules. In either case, the sensitivity of the gas sensor is improved. A method is also provided.

### BACKGROUND OF THE INVENTION

1. Field of the Invention

The present invention relates to gas sensors, and more particularly to a gas sensor which employs a zinc oxide layer as the gas sensitive element to detect gas.

2. Description of Prior Art

A gas sensor is a device having a gas sensitive element. When the gas sensitive element absorbs an amount of gas, this induces a change in a characteristic (e.g. electrical conductivity) of the gas sensitive element. By detecting and measuring the change, the amount of gas absorbed by the gas sensitive element can be calculated. Thus gas sensors are widely used to detect exhaust gases or toxic gases, in fields such as automobiles and air pollution management.

A gas sensor with a zinc oxide layer employs the zinc oxide layer as the gas sensitive element, and is for detecting carbon monoxide (CO), nitrogen dioxide (NO₂) and other toxic gases. In principle, when a surface of the zinc oxide layer absorbs a certain amount of gas, a conductance of the zinc oxide layer changes. By detecting the extent of the change in conductance, the amount of gas absorbed can be calculated. A loose zinc oxide layer has many apertures between adjacent zinc oxide particles, which is conducive to the absorption of gases. The looseness of the structure of the zinc oxide layer is one of the most important factors which increases the sensitivity and response time of the gas sensor.

Referring to FIG. 3, a conventional gas sensor 1 includes an alumina base 10, two electrodes 11, 12 formed on the alumina base 10, and a zinc oxide layer 14 formed on the alumina base 10 and the the electrodes 11, 12. A method of forming the zinc oxide layer 14 includes the steps of plating nano-crystals of zinc on the base 10 and the electrodes 11, 12 to form a zinc layer, and gradually heating the zinc layer in air to thereby form the zinc oxide layer 14. During heating of the zinc layer, it is common for a zinc oxide film to initially form on the outer surface of the zinc layer. The zinc oxide film then prevents inner portions of the zinc layer from oxidizing. In order to overcome this problem, the zinc layer is heated to very high temperatures. This ensures that the whole zinc layer is oxidized into a zinc oxide layer.

However, when the nano-crystals of zinc are heating to very high temperatures, this reduces the looseness of the structure of the zinc oxide layer. The diameters of the zinc oxide particles increase with increasing temperature, and apertures between the zinc oxide particles decrease in size or even disappear. Thus the sensitivity of the zinc oxide layer is reduced. Accordingly, an improved zinc oxide gas sensor that has high sensitivity is desired.

### SUMMARY OF THE INVENTION

An object of the present invention is to provide a gas sensor with a zinc oxide layer, the gas sensor having high sensitivity.

Another object of the present invention is to provide a method for forming the gas sensor with a zinc oxide layer.

In order to achieve the first above-mentioned object, a gas sensor includes a base, two electrodes formed on the base, and a zinc oxide layer formed on surfaces of the base and the electrodes. The zinc oxide layer comprises a plurality of zinc oxide nanofibers. Each zinc oxide nanofiber has a columnar or a tubular microstructure, the microstructure being selected according to need. Preferably, the zinc oxide nanofibers are substantially parallel to each other and substantially perpendicular to the base and electrodes. If the microstructure is columnar, numerous apertures between adjacent zinc oxide nanofibers can retain gas molecules. If the microstructure is tubular, apertures within the zinc oxide nanofibers and apertures between adjacent zinc oxide nanofibers can retain gas molecules. In either case, the sensitivity of the gas sensor is improved.

In order to achieve the second above-mentioned object, a method for forming the gas sensor comprises: providing a base; forming two electrodes on the base; and forming a zinc oxide layer having a plurality of zinc oxide nanofibers on the base and the electrodes, each zinc oxide nanofiber having a columnar or a tubular microstructure.

These and other features, aspects and advantages of the invention will become more apparent from the following detailed description, claims and the accompanying drawings, in which:

### BRIEF DESCRIPTION OF THE DRAWINGS

FIG. 1 is a cross-sectional view of a gas sensor in accordance with a preferred embodiment of the present invention;

FIG. 2 is an enlarged view of a circled portion II of FIG. 1;

FIG. 3 is a cross-sectional view of a conventional gas sensor having a zinc oxide layer as the gas sensitive element.

### DETAILED DESCRIPTION OF THE PRESENT INVENTION

Reference will now be made to the drawings to describe a preferred embodiment of the present invention in detail.

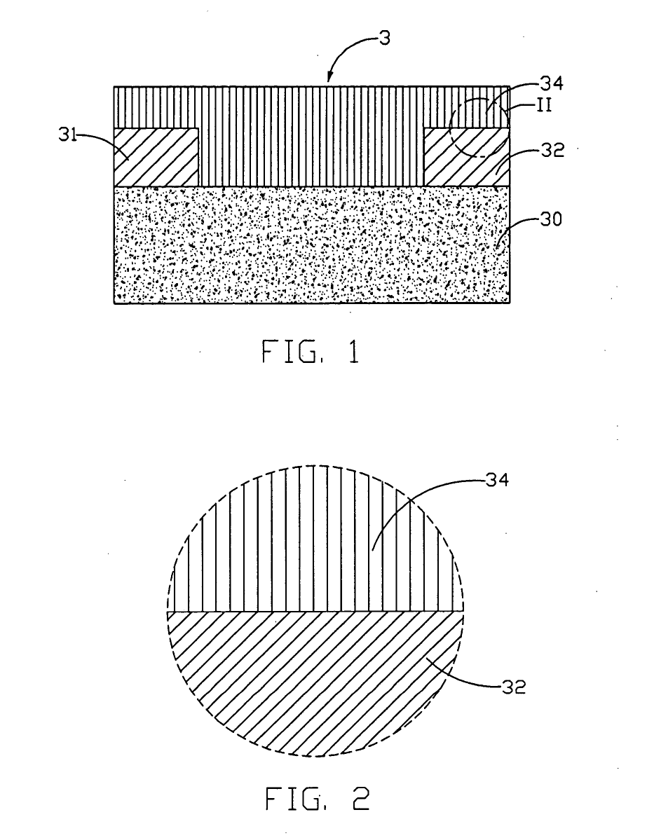

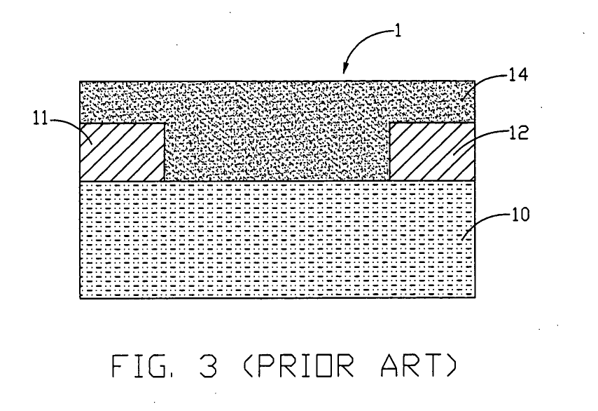

Referring to FIGS. 1 and 2, a gas sensor 3 of the present invention comprises a base 30, two electrodes 31, 32 formed on the base 30, and a zinc oxide layer 34 formed on the base 30 and the electrodes 31, 32. The zinc oxide layer 34 is made of a plurality of zinc oxide nanofibers, each having a columnar or tubular microstructure. The particular microstructure can selected according to need. Preferably, the zinc oxide nanofibers are substantially parallel to each other and substantially perpendicular to the base 30.

A method for forming the gas sensor 3 comprises the steps of providing the base 30, forming the two electrodes 31, 32 on the base 30, and forming the zinc oxide layer 34 on surfaces of the base 30 and the electrodes 31, 32. The base 30 can be a thin sheet or a thin film. Usually the base 30 is made of a material having good electrical insulation, such as alumina, quartz, a ceramic material, silicon nitride, and so on. Because the gas sensor 3 usually operates at high temperatures, the material of the base 30 preferably has good heat conductivity.

The electrodes 31, 32 are formed on the base 30 by a known deposition or sputtering method, and have a predetermined pattern and a predetermined thickness. The material of the electrodes 31, 32 can be platinum, or gold, or alloys thereof. The thickness of the electrodes 31, 32 is preferably in the range from 400 nanometers to 7000 nanometers. The electrodes 31, 32 include conducting wires (not shown), which respectively connect the electrodes 31, 32 with a power source (not shown). The number, the pattern, and the thickness of the electrodes 31, 32 can be varied according to need.

The zinc oxide layer 34 is formed on the surfaces of the base 30 and the electrodes 31, 32 by magnetron sputtering. Beforehand, the base 30 and the electrodes 31, 32 are cleaned using an acidic solution and deionized water, and are then dried by blowing using high purity nitrogen. Different magnetron sputtering apparatuses have different sputtering parameters. In the preferred embodiment, a zinc target having a purity of 99.999% and a diameter of 10 centimeters is employed. Oxygen and argon having a volume ratio of 3:1 are respectively used as the reactive gas and the ambient gas for sputtering. The sputtering power applied is 600 watts. During the sputtering process, the base 30 with the electrodes 31, 32 are rotated, while a temperature in the range from 200 to 300 degrees Celsius is maintained. The formed zinc oxide layer 34 comprises a plurality of zinc oxide nanofibers, each having a columnar or tubular microstructure. The zinc oxide nanofibers are substantially parallel to each other and substantially perpendicular to the base 30.

In an alternative embodiment, the zinc oxide layer 34 is formed by chemical vapor deposition. This method comprises the steps of: placing the base 30 with the electrodes 31, 32 formed thereon in an alumina boat positioned in a reaction furnace, a distance between a center of the base 30 and a center of the alumina boat being in the range from 0.5 to 2.5 centimeters; providing crushed zinc oxide powder and graphite powder as reacting materials in the alumina boat, wherein the graphite powder has a same weight as the zinc oxide powder; introducing argon gas into the reaction furnace, and heating the reaction materials and the base 30 with the electrodes 31, 32 to a temperature in the range from 880-905 degrees Celsius, in order to grow the zinc oxide nanofibers on the base 30 and the electrodes 31, 32. The growth process takes from 2 to 10 minutes. Each of the zinc oxide nanofibers has a columnar or tubular microstructure. The zinc oxide nanofibers are substantially parallel to each other and substantially perpendicular to the base 30. A diameter of the zinc oxide nanofibers is in the range from 20 to 150 nanometers. A height of the zinc oxide nanofibers is about 10 micrometers.

Other deposition methods for forming the zinc oxide layer 34 can be employed. Whichever method is employed, the zinc oxide layer 34 has the zinc oxide nanofibers with a columnar or tubular microstructure. If the microstructure is columnar, numerous apertures between adjacent zinc oxide nanofibers can retain gas molecules. If the microstructure is tubular, apertures within the zinc oxide nanofibers and apertures between adjacent zinc oxide nanofibers can retain gas molecules. Thus in either case, the sensitivity of the gas sensor 3 is improved.

While the present invention has been described with reference to particular embodiments, the description is illustrative of the invention and is not to be construed as limiting the invention. Therefore, various modifications to the present invention can be made to the described embodiments by those skilled in the art without departing from the true spirit and scope of the invention as defined by the appended claims.

1. A gas sensor comprising:
a base;
two electrodes formed on the base; and
a zinc oxide layer formed on surfaces of the base and the electrodes, wherein the zinc oxide layer comprises a plurality of zinc oxide nanofibers each having a columnar or a tubular microstructure.

2. The gas sensor of claim 1, wherein a material of the base is selected from the group consisting of alumina, quartz, ceramic material, and silicon nitride.

3. The gas sensor of claim 1, wherein a material of the electrodes is selected from the group consisting of platinum, gold, and alloys thereof.

4. The gas sensor of claim 1, wherein a diameter of the zinc oxide nanofibers is in the range from 20 to 150 nanometers.

5. The gas sensor of claim 1, wherein a height of the zinc oxide nanofibers is approximately 10 micrometers.

6. A gas sensor comprising:
a base;
at least two electrodes formed on the base; and
a zinc oxide layer formed on surfaces of the base and the electrodes;
wherein the zinc oxide layer comprises a plurality of hollow zinc oxide nanofibers.

7. A method for forming a gas sensor, the method comprising the steps of: providing a base;
forming two electrodes on the base;
developing a zinc oxide layer on at least surfaces of said electrodes to form an electric path therebetween; and
allowing particles in said zinc oxide layer bonded together mostly along a direction substantially perpendicular to said surfaces of said electrodes to have micro-paths between said bonded particles extendable from said surfaces of said electrodes to a very top of said zinc oxide layer.

8. The method of claim 7, wherein the electrodes are formed by way of deposition or sputtering.

9. The method of claim 7, wherein before forming the zinc oxide layer, the base and the electrodes are cleaned by using an acidic solution and deionized water, and then dried by blowing with high purity nitrogen.

10. The method of claim 7, wherein the zinc oxide layer is formed by chemical vapor deposition.

11. The method of claim 7, wherein the zinc oxide layer is formed by magnetron sputtering.

12. The method of claim 11, wherein during formation of the zinc oxide layer by magnetron sputtering, the base with the electrodes are rotated while being maintained at a predetermined temperature.

13. The method of claim 12, wherein the predetermined temperature is in the range from 200 to 300 degrees Celsius.

14. The method of claim 11, wherein in the formation of the zinc oxide layer by magnetron sputtering, a zinc target having a purity of 99.999% and a diameter of 100 milimeters is employed.

15. The method of claim 11, wherein during formation of the zinc oxide layer by magnetron sputtering, oxygen and argon are respectively used as the reactive gas and the sputtering gas.

16. The method of claim 15, wherein during formation of the zinc oxide layer by magnetron sputtering, the oxygen and argon have a volume ratio of 3:1.

17. The method of claim 11, wherein during formation of the zinc oxide layer by magnetron sputtering, a sputtering power of 600 watts is applied.
